(19) United States
(12) Patent Application Publication
(10) Pub. No.: US 2011/0135423 A1
(43) Pub. Date: Jun. 9, 2011

(54) APPARATUS FOR TRANSPORTING AND RAISING PULTRUDED/EXTRUDED UTILITY SUPPORT STRUCTURES

(75) Inventor: Donald S. WILLIAMS, Chicago, IL (US)

(73) Assignee: Duratel, LLC, Chicago, IL (US)

(21) Appl. No.: 12/901,637

(22) Filed: Oct. 11, 2010

Related U.S. Application Data
(63) Continuation-in-part of application No. 12/613,879, filed on Nov. 6, 2009.
Application No. 12/613,879 is a continuation-in-part of application No. 11/803,977, filed on May 16, 2007.
(60) Provisional application No. 60/801,856, filed on May 18, 2006.
(60) Provisional application No. 61/250,647, filed on Oct. 12, 2009.
(60) Provisional application No. 61/250,658, filed on Oct. 12, 2009.
(60) Provisional application No. 61/251,854, filed on Oct. 15, 2009.

(51) Int. Cl. B66F 11/00

(52) U.S. Cl. 414/23

(57) ABSTRACT

An apparatus for transporting and raising pultruded and/or extruded structures. The apparatus is made of plural pullwound pultruded cylindrical structures identical or similar to the pultruded and/or extruded structures. The apparatus allows pultruded and/or extruded structures to be transported, raised and installed in various types of terrain.

### CROSS REFERENCES TO RELATED APPLICATIONS

This utility application is a Continuation-In-Part (CIP) of U.S. application Ser. No. 12/613,879, filed Nov. 9, 2009, which is a CIP of U.S. application Ser. No. 11/803,977, filed May 16, 2007, that claims priority to U.S. Provisional application 60/801,856 filed May 18, 2006. This CIP application also claims priority to U.S Provisional application numbers 61/250,647 and 61/250,658 filed Oct. 12, 2009, 61/251,854, filed Oct. 15, 2009. The contents of all listed applications are incorporated herein by reference.

### FIELD OF INVENTION

This application relates to plutruded and extruded structures. More specifically, it relates to an apparatus for raising pultruded and extruded utility structures.

### BACKGROUND OF THE INVENTION

Most utility poles used today made of wood. Utility poles are divided into ten classes, from 1 to 10. The classes' definition specifies a minimum circumference that depends on the species of tree and the length of the pole. This circumference is measured 6 feet from the butt of the pole. There is also a minimum top circumference that is the same for all species and lengths.

For example, a class 1 pole has a minimum top circumference of 27 inches. If it is 25 feet long and cedar (most utility poles are cedar), the circumference measured 6 feet from the bottom must be at least 43.5 inches.

The higher the class number, the skinnier the pole. Pole lengths start at 16 feet and increase by 2-foot steps to 22 feet, then by fives from 25 feet to 90 feet. A 90-foot class 1 western red cedar pole weighs about 6,600 pounds. A 16-foot pole weighs only about 700.

All utility poles used are pressure treated to preserve the wooden utility poles from the weather, insects and other types of attacks and decay. Utility poles are treated with a number of toxic chemicals including pentachlorphenol, chromated copper arsenate, creosote, copper azole and others.

Pentachlorophenol (Penta) is widely-used wood preservative that is normally dissolved in a petroleum carrier. It is the most commonly used preservative system utilized by North American utilities.

Chromated Copper Arsenate (CCA) is water-borne treatment that offers a wide range of advantages for treated lumber, timber and poles; clean; odorless; paintable. For poles, its use is limited to southern yellow pine, pinus sylvestris, and western red cedar.

Creosote is an oil-based wood preservative blended from the distillation of coal tar and comprised of more than 200 major constituents. Used in industrial applications, such as railroad ties, piling (both salt water and fresh water), and for utility poles.

Copper Azole (CA-B) is a water-borne copper based wood preservative with an organic co-biocide (Tebuconazol). Similar in color, to CCA-C, odorless, clean, paintable or stainable. Copper Azole is approved by the American Wood Preservers Association for use on Western Red Cedar and Southern Yellow Pine utility poles.

There are several problems associated with wooden utility poles. One problem is that utility poles are heavy and bulky and hard to move and install. Another problem is that wooden utility poles are treated with chemicals that are harmful to the environment, and poisonous (e.g. arsenic, etc.) to humans and animals and have been shown in some instance to cause cancers. Another problem is that even with pressure treating the wood, wooden utility poles have to be replaced about every ten years. Another problem is that wooden utility poles are not aesthetically pleasing to look and are typically all a brown or black color.

There are also problems associated with transmission towers to which high voltage electrical lines a are attached. An electricity pylon or transmission tower is a tall, usually steel lattice structure used to support overhead electricity conductors for electric power transmission. The structure is usually made from lynx triangles because if another shape is used it would slowly bend out of shape without bending the joints. The result would be a bent or broken pylon. For example if a rectangle is used it would bend into the shape of a parallelogram due to the associated forces.

One problem is that transmission towers are hard to design, expensive to build and hard to maintain. The transmissions towers are subject to large forces including those related to the transmission components such as wires and cable and environmental forces such as wind, rain, snow, ice, etc.

Another problem is that transmission towers often require additional support. Yet another problem is that transmission towers are difficult for maintenance workers and technicians to climb.

Another problem is that it is difficult to handle and install pultruded and extruded utility structures.

There have been attempts to solve some of these problems. For example, U.S. Pat. No. 7,159,370 that issued to Oliphant, et al. entitled “Modular fiberglass reinforced polymer structural pole system” teaches “This invention is a modular pole assembly comprised of corner pieces and panel members. Panel members are slidably engaged to the corner pieces and are retained in a direction normal to the engagement direction by a track in each slot that nests within a groove in each panel member. corner pieces may include multiple slots along each side, allowing for multiple layers of panel members along each side, thereby increasing strength and allowing an insulative and structural fill material to be added between panel member layers. The height of the modular pole may be increased by inserting splicing posts between consecutive, adjacent corner members and inserting splicing pieces between co-planar adjacent panel members. The modular nature of the pole assembly provides for simple packaging and shipment of the various components and easy assembly at or near the installation location.”

U.S. Pat. No. 6,453,635 that issued to Turner entitled “Composite utility poles and methods of manufacture” teaches “Composite utility pole structures and methods of manufacture using a pultrusion process. The poles may be N sided, with longitudinal pre-stressed rovings in each corner. The inner periphery of the poles may have flat regions centered between the outside corners, with the flat regions joined by circular arcs in the corner regions. Various pole structures and methods of manufacture are described, including curved poles and poles having walls that are tapered in thickness and structure.”

U.S. Pat. No. 6,357,196 that issued to McCombs entitled “Pultruded utility pole” teaches “A hollow fiberglass utility pole includes a pair of segments that are a fiberglass sheet that has a semicircular cross-section. The segments have first and second longitudinal edges with male and female couplers respective shapes that have a complimentary relationship to each other for mechanical engagement thereof. The fiberglass pole is assembled by engaging the first longitudinal edge of one segment with the second longitudinal edge of the other segment at an installation site. The fiberglass pole may be used as a sheath to encase an existing wooden pole.”

U.S. Pat. No. 5,311,713 that issued to Goodrich entitled Electric and telephone pole ground protector teaches “A device and method for protecting the end of a wooden utility pole set in the ground. A split cylindrical casing is provided which can be placed around the lower end of a wooden utility pole just before it is installed in the ground. The casing comprises an elongate, relatively thin cylindrical member having one closed end and being split into two sections connected together along the side thereof. The connection acts as a hinge. The edges of the casing where it is split are provided with a fastener, one part of the fastener being disposed along the edge of one part of the casing and another part of the fastener being disposed along the edge of the other part of the casing. When the cylindrical casing is closed, the edge of one part overlaps the edge of the other part so that the respective parts of the fasteners fit matingly together. Preferably, the fastener extends the entire length of the casing and entirely across the bottom end thereof. Preferably, the casing is made of high grade plastic.”

U.S. Pat. No. 5,175,971 that issued to Maccomb entitled “Utility power pole system” teaches “A utility power pole system comprises a pultruded hollow primary pole having an external hexogonal cross section and a number of longitudinal exterior grooves along its length. The hollow primary pole also has an internal hexogonal cross section rotated 30.degree. relative to the external hexagonal cross section. One or more pultruded hollow liners are provided which are also hexagonal in cross section and which may be internally or externally concentric with the primary pole. These liners vary in length to achieve an effective structural taper to the power pole system. The insertion of a tapered liner in the lower portion of the utility pole results in a utility pole having the effective load bearing capability of a tapered utility pole. By using a plurality of overlapping liners of varying lengths, an effective taper can be provided to the utility pole. The longitudinal grooves in the outer surface of the primary pole provide a means for climbing for a utility lineman and a means for attaching accessory attachment devices such as cross arms, stiffening members, conductor supports and for interconnection with other structural elements in a more extensive system. The rounded edges of each longitudinal groove are directed inwardly so as to retain devices in the groove which conform to the cross section of the groove. Cross arms attached to the utility pole may also employ similar longitudinal grooves to facilitate interconnection with existing utility hardware or other components.”

U.S. Pat. No. 4,803,819 that issued to Kelsey entitled “Utility pole and attachments formed by pultrusion of dielectric insulating plastic, such as glass fiber reinforced resin” teaches “a utility pole and attachments formed by pultrusion of dielectric insulating plastic, such as glass fiber reinforced resin.”

However, none of these solutions overcome all of the problems with utility poles and utility structures. Thus, it would be desirable to solve some of the problems associated with utility poles and utility structures.

### SUMMARY OF THE INVENTION

In accordance with preferred embodiments of the invention, some of the problems associated with utility poles and utility structures are overcome. An apparatus for raising pultruded and/or extruded structures is presented.

The apparatus is of made of plural pullwound pultruded cylindrical structures identical or similar to the pultruded and/or extruded structures. The apparatus allows pultruded and/or extruded structures to be transported, raised and installed in various types of terrain.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating a side view of an exemplary extruded hollow structure;

FIG. 2 is a block diagram illustrating a top view of an exemplary extruded hollow structure;

FIG. 3 illustrates a cross-section of a pultruded hollow structure;

FIG. 4 illustrates a cross-section of an exemplary pultruded hollow structure;

FIG. 5 illustrates a block diagram of a side view of an exemplary pultruded hollow structure;

FIG. 6 is a block diagram illustrating an exemplary transmission support structure;

FIG. 7 is a block diagram illustrating another exemplary transmission support structure;

FIG. 8 is a block diagram illustrating a side view of an exemplary transmission structure support component;

FIG. 9 is a block diagram illustrating an additional support component for the exemplary transmission support structure;

FIG. 10 is a block diagram illustrating an internal support component for an exemplary transmission support structure;

FIG. 11 is a block diagram illustrating an internal support component for an exemplary transmission support structure within pultruded hollow cylindrical component;

FIG. 12 is block diagram illustrating an attachable/detachable climbing component used on the exemplary utility line support structure;

FIG. 13 is a block diagram illustrating an apparatus that does not include any power source and needs to be pulled with a vehicle or via a human puller;

FIG. 14 is a block diagram illustrating an apparatus that includes a power source and does not need to be pulled with a vehicle or via a human puller; and

FIG. 15 is a block diagram illustrating a pull winding, pultrusion process.

### DETAILED DESCRIPTION OF THE INVENTION

Exturded Utility Structures

“Extrusion” is a manufacturing process where a material is pushed and/or drawn through a die to create long objects of a fixed cross-section. Hollow sections are usually extruded by placing a pin or mandrel in the die. Extrusion may be continuous (e.g., producing indefinitely long material) or semi-continuous (e.g., repeatedly producing many shorter pieces). Some extruded materials are hot drawn and others may be cold drawn.

The feedstock may be forced through the die by various methods: by an auger, which can be single or twin screw, powered by an electric motor; by a ram, driven by hydraulic pressure, oil pressure or in other specialized processes such as rollers inside a perforated drum for the production of many simultaneous streams of material.

Plastic extrusion commonly uses plastic chips, which are heated and extruded in the liquid state, then cooled and solidified as it passes through the die. In some cases (such as fiber reinforced tubes) the extrudate is pulled through a very long die, in a process called “pultrusion.”

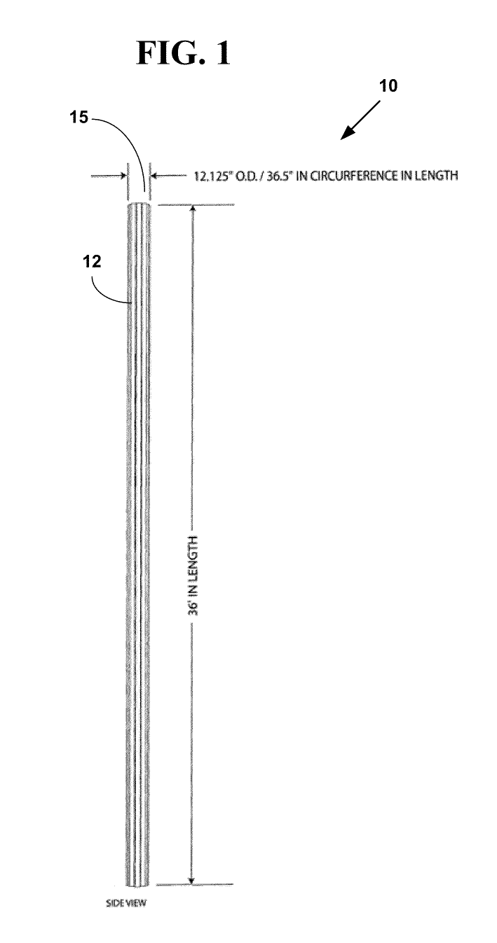

FIG. 1 is a block diagram illustrating a side view 10 of an exemplary extruded hollow structure 12.

In one embodiment, the extruded structure 12 comprises extruded plastic materials including, but not limited to, Polyvinyl Chloride (PVC), Acrylonitrile Butadiene Styrene (ABS), High Impact Polypropylene (HIP), Polypropylene, High-Density Polyethylene (HDPE), Polycarbonate, Polyethylene Terephthalate Glycol (PETG), Nylon, Fiber reinforced Polypropylene, Fiber Reinforced Plystyrene and other types of plastics. In another embodiment, the extruded structure 12 comprises composite materials. In another embodiment, the extruded structure 12 comprises recycled plastic materials.

The extruded structure 12 is extruded in plural different colors (e.g., red, green, yellow, blue, brown, etc.) and is aesthetically pleasing. The plural different colors may blend in with a natural environmental setting or a pre-determined design scheme. For example, a new subdivision may include only blue extruded utility poles.

In one exemplary embodiment, the extruded structure 12 is an extruded plastic utility pole 12 of extruded to a length of at least 36′ in length. The exemplary extruded structure 12 has an outside at least 12.125″ and a 36.5″ circumference. However, the present invention is not limited to the dimensions described and other extruded utility poles 12 of other lengths and dimensions can also be used to practice the invention.

In one embodiment, the extruded structure 12 includes a pre-determined length (e.g., 8 feet, 16 feet, 24 feet, 36 feet, 40 feet, 65 feet etc.). However, the present invention is not limited to these lengths and other lengths can be used to practice the invention.

In one embodiment, a 36′ length of the extruded structure 12 weighs about 100 pounds. It is estimated that a 36′ length of the extruded structure 12 has a tensile strength of about 8,500 pounds per square inch (PSI). As is known in the art, the “tensile strength” is a maximum stress that a material can withstand before necking As is known in the art “necking” is a mode of deformation where relatively large amounts of strain localize disproportionately in a small region of an object. As is known in the art, “hoop strength” includes strength against a circumferential stress in a cylindrically shaped part as a result of an internal or external pressure.

It is estimated that an extruded structure 12 would have a lifetime of over 100 years and be safe to the environment, humans and animals. The extruded structure 12 is resistance to damage from the weather, animals, insects and is corrosion resistant.

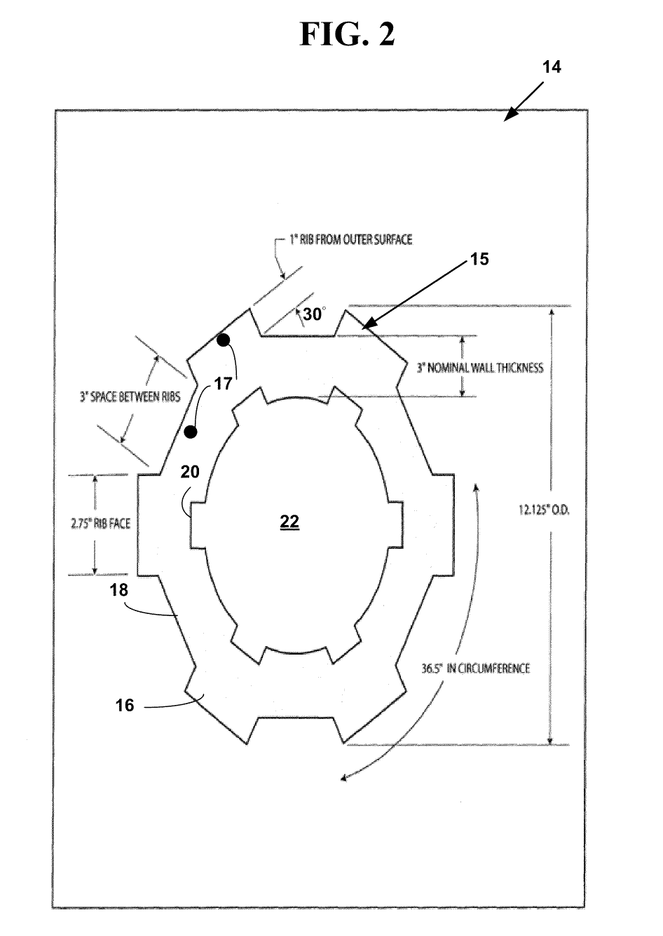

FIG. 2 is a block diagram illustrating a top view 14 of an exemplary extruded structure 15. In one exemplary embodiment, the exemplary extruded structure 12 includes plural ribbed faces. The plural rib faces 16 are connected with plural angular faces 18. An inner surface of the plural rib faces 16 includes plural intrusions 20. The plural intrusions 20 are in alignment with the plural ribbed faces 16.

In one embodiment the plural intrusions 20 are used a channel to hold plural different sets of wires such as communications wires or antenna wires.

FIG. 2 is illustrated with an exemplary embodiment. However, the present invention is not limited to such an embodiment and other embodiments can also embodiments can also be used to practice the invention.

In such an embodiment, exemplary extruded structure 12 includes plural flat rib faces 16. In one embodiment, the plural flat rib faces include a width of about 2.75″. The plural flat rib faces 16 comprise a rib of about 1″ from the outer surface of the extruded structure 12. The plural flat rib faces 16 are connected with plural angular faces 18. In one embodiment, the plural angular faces 18 include an angle of about 30 degrees and a flat surface of about 3″ in width. The extruded utility pole includes a circumference of about 36.5″ and an outside diameter of about 12.125″. An inner surface of the plural flat rib faces 16 includes plural flat intrusions 20. The plural flat intrusions 20 can be used a channel to hold plural different sets of wires such as communications wires or antenna wires.

However, the present invention is not limited to the shapes and dimensions described and other extruded structures 12 of other shapes and dimensions can also be used to practice the invention.

In one embodiment, the extruded structure 12 includes one or more receptacles are pre-determined heights in the plural flat rib faces 16. In such an embodiment, the one or more receptacles are used for adding utility components such utility boxes, etc. The one or more receptacles may include pre-determined features such as a screw pattern or other pattern for inserted a screw or other attachment means.

In another embodiment, the plural flat rib faces 16 include plastic, nylon, composite materials or other types of filaments to add additional strength to the extruded structure 12.

In another embodiment, the plural flat rib faces 16 include integral copper wires 17 that allow the extruded structure 12 to be used an antenna for wireless or other types of communications. In another embodiment, the integral copper wires are embedded into other surfaces of extruded structure 12.

FIG. 2 illustrates an extruded structure 12 with a hollow core 22. In such an embodiment, communications wires (e.g., fiber optic, copper, coaxial cable, etc.) or antenna wires can be run through the hollow core (as well as the plural flat intrusions 20) to connect to other communications wires buried underground in dirt or sub-terrain pipes or tunnels. This avoids connecting unsightly communications wires between two or more extruded structure 12 and protects the communications wires or antenna wires from damage by the weather and animals.

FIG. 2 illustrates an extruded structure 12 with a hollow core. However, the present invention is not limited to this embodiment and the extruded structure 12 can be extruded as solid piece of material. In such an embodiment, the weight of the extruded structure 12 would be more than 100 pounds and have a different tensile strength.

In one embodiment, the extruded structure 12 includes a fiber or webbing re-enforced cylindrical structure comprising a utility pole, a lighting pole, a structural support, an architectural design element (interior or exterior), a marine dock element or a fencing element.

In one embodiment, the extruded structure 12 includes additional fiberglass, plastic, ester, polyester, nylon, composite materials or other types of filaments or webbing to add additional strength to the extruded structure 12. The filaments or webbing are applied internally or externally to the extruded structure 12.

The structure of the external and internal surfaces in an alternating and repeating pattern of the extruded structure 12 provides additional tensile strength to the structure. In addition, the angular lines of the structure are aesthetically pleasing.

In addition, the shape of the extruded structure 12 provides an optimal resistance, or near optimal resistance to wind shear forces.

Pultruded Utility Structures

As is known in the art, “pultrusion” is a manufacturing process for producing continuous lengths of materials. Pultrusion raw materials include a liquid resin mixture (e.g., containing resin, fillers and specialized additives) and reinforcing fibers (e.g., fiberglass, composite materials, etc.). The process involves pulling these raw materials (rather than pushing as is the case in extrusion) through a heated steel forming die using a continuous pulling device. The reinforcement materials are in continuous forms such as rolls of fiberglass mat or doffs of fiberglass roving. As the reinforcements are saturated with the resin mixture in the resin impregnator and pulled through the die, the gelatin (or hardening) of the resin is initiated by the heat from the die and a rigid, cured profile is formed that corresponds to the shape of the die.

There are also protruded laminates. Most pultruded laminates are formed using rovings aligned down the major axis of the part. Various continuous strand mats, fabrics (e.g., braided, woven and knitted), and texturized or bulked rovings are used to obtain strength in the cross axis or transverse direction.

The pultrusion process is normally continuous and highly automated. Reinforcement materials, such as roving, mat or fabrics, are positioned in a specific location using preforming shapers or guides to form a pultrusion. The reinforcements are drawn through a resin bath where the material is thoroughly coated or impregnated with a liquid thermosetting resin. The resin-saturated reinforcements enter a heated metal pultrusion die. The dimensions and shape of the die define the finished part being fabricated. Inside the metal die, heat is transferred initiated by precise temperature control to the reinforcements and liquid resin. The heat energy activates the curing or polymerization of the thermoset resin changing it from a liquid to a solid. The solid laminate emerges from the pultrusion die to the exact shape of the die cavity. The laminate solidifies when cooled and it is continuously pulled through the pultrusion machine and cut to the desired length. The process is driven by a system of caterpillar or tandem pullers located between the die exit and the cut-off mechanism.

In one embodiment the pultrusion resins include bisphenol—a epichlorohydrin-based vinyl esters. In another embodiment, the resins include polyesters including isophthalic, orthophthalic, propylene-maleate, fire resistant, and high cross-link density. However, the present invention is not limited to these resins and other resins can be used to practice the invention.

In one embodiment, the pultrusions include re-enforcing fibers comprising, fiberglass fibers, composite fibers, etc. However, the present invention is not limited to these resins and other resins can be used to practice the invention.

One resin used in fiberglass pultrusions is a thermoset resin. The resin used in Polyvinyl Chloride (PVC) pultrusions are typical thermoplastic resins. In the pultrusion process, under heat and pressure, the thermoset resins and re-enforcing fibers form a new inert material that is impervious to temperature. Pultruded fiberglass physical properties do not change through the full temperature cycle up to temperatures of about 200 degrees Fahrenheit (° F.). In direct contrast, PVC resins typically become unstable at temperatures greater than 155° F.

Pultrusions, include but are not limited to, structures comprising: (1) HIGH STRENGTH—typically stronger than structural steel on a pound-for-pound basis; (2) LIGHTWEIGHT—Pultrusions are 20-25% the weight of steel and 70% the weight of aluminum. Pultruded products are easily transported, handled and lifted into place; (3) CORROSION/ROT RESISTANT—Pultruded products will not rot and are impervious to a broad range of corrosive elements; (4) NON-CONDUCTIVE—fiberglass reinforced pultrusions have low thermal conductivity and are electrically non-conductive; (5) ELECTRO-MAGNETIC TRANSPARENT—Pultruded products are transparent to radio waves, microwaves and other electromagnetic frequencies; (6) DIMENSIONAL STABILE—The coefficient of thermal expansion of pultruded products is slightly less than steel and significantly less than aluminum; (7) LOW TEMPERATURE CAPABLE—FiberGlass fiber reinforced pultrusions exhibit excellent mechanical properties at very low temperatures, even −70° F. Tensile strength and impact strengths are greater at −70° F. than at +80° F.; (8) AESTHETICLY PLEASING—Pultruded profiles are pigmented throughout the thickness of the part and can be made to virtually any desired custom color. Special surfacing veils are also available to create special surface appearances such as wood grain, marble, granite, etc.; and (9) COST EFFICTIVE—pultruded products are cheaper than those made of metals, wood, etc. and other materials.

In another embodiment the extruded utility structures described above and illustrated in FIGS. 1 and 2 are pultruded. In such embodiments a pultrusion die is created based on the desired design shape illustrated FIG. 2.

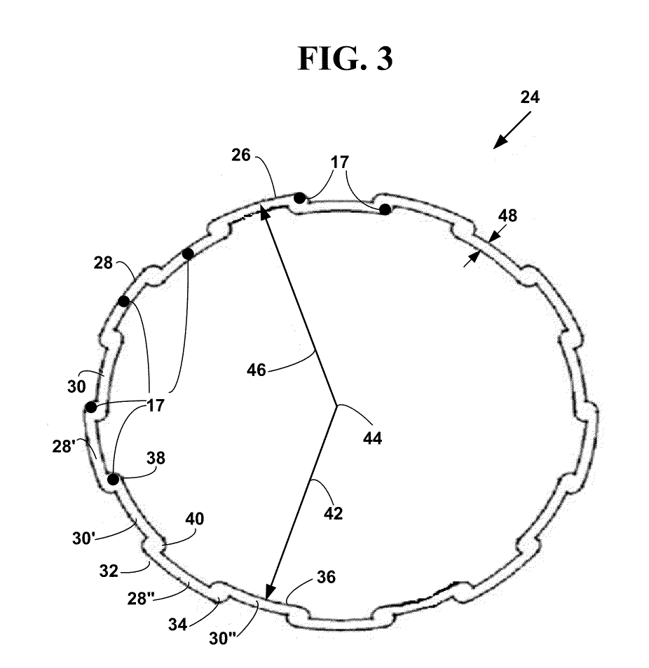

FIG. 3 illustrates a cross-section of a pultruded hollow cylindrical structure 24. In one embodiment the pultruded hollow cylindrical structure includes an external surface 26 including plural protruding components 28 connected to plural intruding components 30. A protruding component 28′ includes two curved components 32, 34 for connecting the protruding component 28′ to two other intruding components 30′ and 30″.

The pultruded hollow cylindrical structure 24 further includes an internal surface 36 including plural intruding components 30 connected to the plural protruding components 28. An intruding component 30′ includes two curved components 38, 40, to connect the intruding component 30′ to two other protruding components 28′ and 28″

The curved components 32, 34, 38, 40 include a pre-determined radius with two outer radius portions on an protruding component 28′ and two inner radius portions on an intruding component 30′.

The pultruded hollow cylindrical structure includes a pre-determined inner radius 42 from a center point 44 to an inner portion of the internal surface 36 and includes a pre-determined outer radius 46 from the center point 44 to an outer portion of the external surface 26. The difference between the pre-determined inner radius and pre- determined outer radius determines a thickness 48 of the pultruded hollow cylindrical structure 24. The thickness 48 was determined experimentally to provide maximum tensil strength, torsional strength and hoop strength.

The pultruded hollow cylindrical structure 24 includes a pre-determined length and a pre-determined color.

In one embodiment, a pultrusion die is created with the design shape and dimensions illustrated in FIG. 3. However, the present invention is not limited to such an embodiment and other embodiments with other dimensions can be used to practice the invention.

The structure of the external and internal surfaces in an alternating and repeating pattern of the pultruded hollow cylindrical structure 14, 24. It has been determined experimentally that the repeating pattern of alternating curved inner and outer surfaces push against in each in a manner to distribute forces (e.g., wind, etc.) downward (instead of sideways or twisting) along a length of the pultruded hollow cylindrical structure 14, 24. This provides provide maximum tensil strength, torsional strength and hoop strength to the structure.

In addition, the curved lines of the repeating pattern of the pultruded hollow cylindrical structure 14, 24 are aesthetically pleasing. In addition, the curved shape of the pultruded hollow cynlindrical structure 14, 24 provide an optimal resistance, or near optimal resistance to wind shear forces by providing plural channels to distribute the wind forces.

FIG. 3 illustrates a pultruded hollow cylindrical structure 24 with a hollow core. However, the present invention is not limited to this embodiment and the pultruded structure 24 can be pultruded as solid piece of material by changing the plutrusion die.

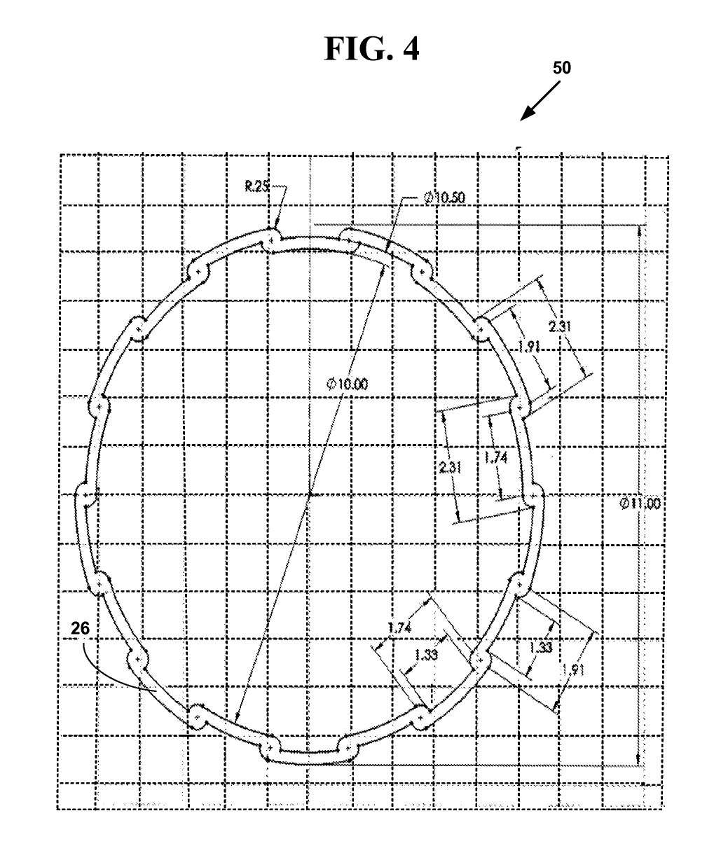

FIG. 4 illustrates a cross-section of an exemplary pultruded hollow structure 50.

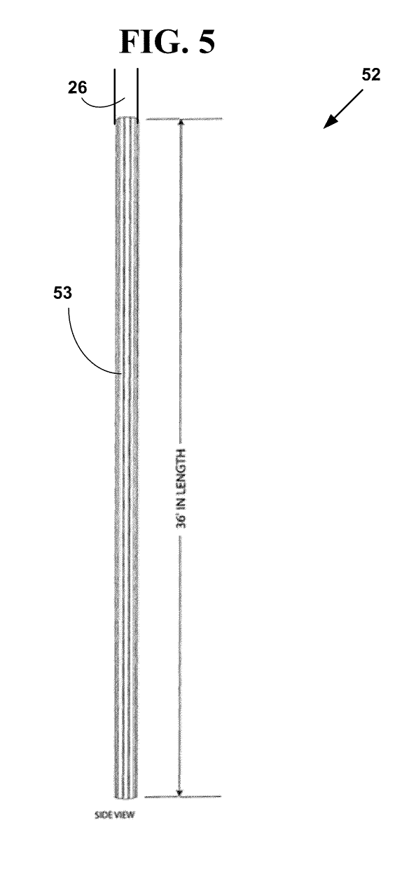

FIG. 5 illustrates a block diagram 52 of a side view of an exemplary pultruded hollow structure 53. In this figure the pultruded hollow cylindrical structure 53 includes the pultruded hollow cylindrical structure 24 with a hollow core 26 as is illustrated in FIG. 3.

The pultruded hollow cylindrical structure 53 is illustrated with an exemplary embodiment as is illustrated in FIG. 4. However, the present invention is not limited to this embodiment and other embodiments can also be used to practice the invention.

In one embodiment, the pultruded hollow cylindrical structure 53 includes a cylindrical structure comprising a utility pole, a lighting pole, a structural support, an architectural design element (interior or exterior), a marine dock element or a fencing element, etc.

The pultruded hollow cylindrical structures 14, 24 include a pre-determined length (e.g., 8 feet, 16 feet, 24 feet, 36 feet, 40 feet, 65 feet etc.). However, the present invention is not limited to these lengths and other lengths can be used to practice the invention.

The pultruded hollow cylindrical structures 14, 24 includes plural different colors (e.g., red, green, yellow, blue, brown, etc.) and is aesthetically pleasing. The plural different colors may blend in with a natural environmental setting or a pre-determined design scheme. For example, a new subdivision may include only blue utility poles, while a boat dock may include only high visibility orange decking comprising the pultruded hollow cylindrical structures 14, 24. However, the present invention is not limited to these colors and other colors can be used to practice the invention.

The pultruded hollow cylindrical structure 24 includes a repeating pattern of alternating protruding and intruding components.

In one embodiment, the pultruded hollow cylindrical structure 24 includes one or more receptacles at pre-determined heights. In such an embodiment, the one or more receptacles are used for adding utility components such utility boxes, etc. The one or more receptacles may include pre-determined features such as a screw pattern or other pattern for inserted a screw or other attachment means.

In one embodiment, the plural protruding components and plural intruding components include additional fiberglass, plastic, ester, polyester, nylon, composite materials or other types of filaments or webbing to add additional strength to the pultruded hollow cylindrical structure 24. The filaments or webbing are applied internally or externally to the pultruded hollow cylindrical structure 24.

In another embodiment, the pultruded hollow cylindrical structure 24 includes integral copper wires 17 in or more surfaces that allow the structure to be used an antenna for wireless or other types of communications.

Various exemplary and specific measurements are described herein. However, the present invention is not limited to these exemplary and specific measurements. In addition, the extruded and pultruded structures described herein can be made with specific measurements for actual products such as 2×4's, structural beams, fencing, wooden telephone poles, etc. In such embodiments, the extruded or pultruded structures may be thicker then necessary and may include the shapes of the actual products instead of the shapes describe herein.

Utility Line Support Structures

In another embodiment, the extruded or pultruded structures include a utility line support structure.

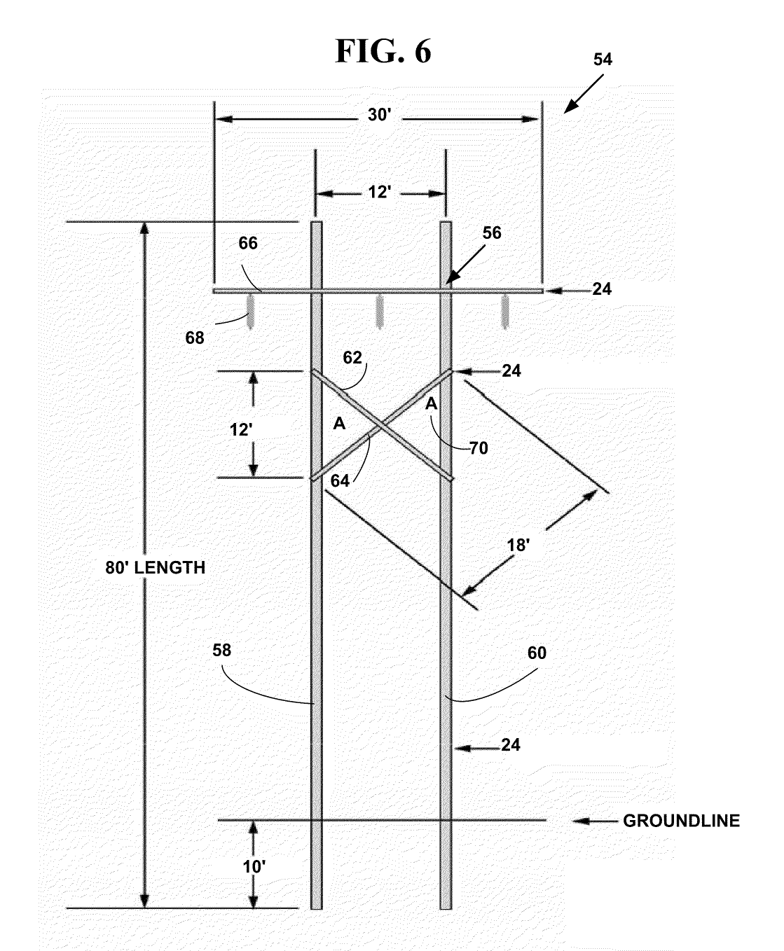

FIG. 6 is a block diagram 54 illustrating an exemplary utility line support structure 56. The utility line support structure is easier to design, install and maintain than transmission towers designed and built from steel, wood and other materials. No special triangular or trapezoidal design is necessary with structure 56.

The exemplary utility line support structure 56 is composed of a first and a second hollow cylindrical structures comprising two leg components 58, 60 having two legs extending upward in an H-frame shape. In one embodiment, the first leg component 58 and the second leg component 60 include either extruded structures (FIGS. 1-2) and/or pultruded structures (FIGS. 3-5) or any combination thereof. However, the present invention is not limited to these structures and other structures can also be used to practice the invention.

The utility line support structure 56 includes a pair of composite cross braces 62, 64 that extend between and are connected at their ends between two leg sections 58, 60 and include a support structure in the shape of the letter “X”. However, the present invention is not limited to this attachment shape and other attachment shapes can also be used to practice the invention.

In one embodiment, a first end and a second end of the first cross-brace 62 and the second cross-brace 64 are connected at a pre-determined angle-A 70 between the first leg 58 and the second leg 60. In one embodiment, a length between attaching the cross braces 62, 64 to the two leg sections 58, 60 at the pre-determined angle-A 70 is at a length of at least 12 feet. However, the present invention is not limited to this attachment length and other lengths can also be used to practice the invention.

In one exemplary embodiment, the first cross-brace 62 and second cross brace 64 include a length of 18 feet. However, the present invention is not limited to these lengths and other lengths can also be used to practice the invention.

In one embodiment, the two cross braces 62, 64 include either extruded structures 10 (FIGS. 1-2) and/or pultruded structures 52 (FIGS. 3-5) or any combination thereof. However, the present invention is not limited to these structures and other structures can also be used to practice the invention.

In another specific exemplary embodiment, the first cross-brace 62 and the second cross-brace 64 include an extruded and/or pultruded hollow cylindrical structure (FIGS. 1-5) with and outer diameter of 4.125″, and inner diameter of 2.25″, a thickness of 0.25″ and a length of 18 fee. However, the present invention is not limited to these sizes and measurements and other sizes and measurements can also be used to practice the invention. For example the structure 56 may include hollow cylindrical structures for all components what are the same size and shape.

In one embodiment, the cross braces 62, 64 attach to the leg sections 58, 60 by a through bolt and washer. A through bolt and washer join the cross braces 62, 64 at their intersection. However, the present invention is not limited to such an attachment mechanisms and other attachment mechanisms can also be used to practice the invention.

In one embodiment, the two leg sections 58, 60, comprise the hollow pultruded structures 52 illustrated in FIGS. 3-5 but with an overall length of 80 feet. In another embodiment, the two leg sections 58, 60 comprise the hollow extruded structures 10 illustrated in FIGS. 1-2 but with an overall length of 80 feet. However, the present invention is not limited to these structures and other structures can also be used to practice the invention.

In one embodiment, the two leg sections 58, 60 are buried below ground level with a depth of at least 10 feet. However, the present is not limited to such a burial depth and other burial depths and lengths can be used to practice the invention.

The structure 56 is directly embedded into the ground with or without the use of a reinforced concrete footing, depending on soil content, environment, and required load for the structure. The different components of the structure 56 can be all a same color, all in varying colors, or various combinations thereof of color for aesthetics or identifying specific needs.

At the top of the leg sections 58, 60 a cross arm component 66 for supporting electric transmission components 68, electrical sub-transmission components, electrical distribution lines and other loads is connected at attachment points to the first and second leg component 58, 60. The cross arm component 66 horizontally extends past the first and second leg components at a pre-determined distance.

In one embodiment, the cross arm component 66 includes either hollow extruded structures 10 (FIGS. 1-2) and/or pultruded structures 52 (FIGS. 3-5) or any combination thereof. However, the present invention is not limited to these structures and other structures can also be used to practice the invention.

In one specific exemplary embodiment, the cross arm component 66 includes an extruded and/or pultruded hollow cylindrical structure 10, 52 (FIGS. 1-5) with and outer diameter of 6″, and inner diameter of 4″ and a thickness of 0.25″ and a length of 30 feet. However, the present invention is not limited to these sizes and measurements and other sizes and measurements can also be used to practice the invention.

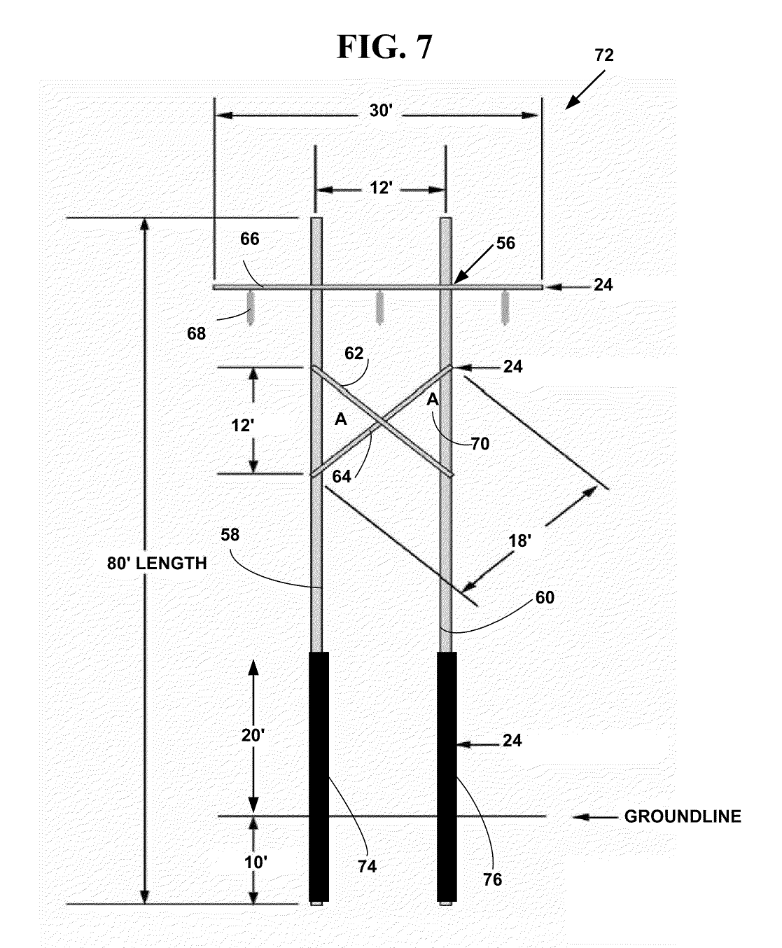

FIG. 7 is a block diagram 72 illustrating another exemplary utility line support structure 56.

A third leg component 74 and a fourth leg component 76 each comprising the hollow cylindrical structure at a fourth pre-determined length are included as components of structure 56. The pre-determined radius with the two outer radius portions on the protruding component and two inner radius portions are larger than the two outer radius portions on the protruding component and two inner radius portions used for the first leg component and the second leg component. A thickness of the hollow cylindrical structure for the third leg component 74 and the fourth leg component 76 is greater than the thickness of the hollow cylindrical component used for the first leg 58 component and the second leg component 60. The third leg component 74 and the fourth leg component 76 are securely embedded into a surface composite utility line support structure. The first leg component 58 since it is smaller in radius is placed within the third leg component 74 and the second leg component 60 since it is smaller in radius is placed in the fourth leg component 75, thereby providing additional strength for the composite utility line support structure 56. The shape of the leg components also provides inter-locking, thereby providing additional structure to the structure that would not have been obtained if the leg components were a smooth circular shape.

In one example, FIG. 2 illustrates an extruded hollow cylindrical structure 16 with an outer diameter of 12.125″, and inner diameter of 9.125″ and a 3″ thickness. In one exemplary embodiment, the third leg component 72 and the fourth leg component 74 include an inner diameter of 10.125″ and an outer radius of 13.125″ and thickness of 3.5″. However, the present invention is not limited to this measurements and other measurements can also be used to practice the invention.

In another example, FIG. 4 illustrates a pultruded hollow cylindrical component 50 with an inner diameter of 10″ and an outer diameter of 11″ and a thickness of 0.25″. In one exemplary embodiment, the third leg component 72 and the fourth leg component 74 include an diameter of 12″ and an outer diameter of 13″ and thickness of 0.5″. However, the present invention is not limited to this measurements and other measurements can also be used to practice the invention.

In one exemplary embodiment, the third leg component 72 and the fourth leg component 74 include a pre-determined length of 40 feet for burial at a 10 foot depth, with 30 feet exposed above a ground line for engaging the first and second leg components 58, 60. In one embodiment, the third leg component 72 and the fourth leg component 74 are equal in length. In another embodiment, the third leg component 72 and the fourth leg component 74 are not-equal in length and are used in areas where the terrain is sloped or un-even or includes natural barriers against insertion such as rock outcrops, rivers, streams, etc. However, the present invention is not limited to these lengths and measurements and other lengths measurements can also be used to practice the invention.

In another embodiment, the first, second, third and fourth leg components 58, 60, 72 and 74 include various combinations of the extruded and pultruded hollow cylindrical components 10, 50, thereby providing different types of inter-locking between the hollow cylindrical components with differences in additional strength.

Additional Support Components

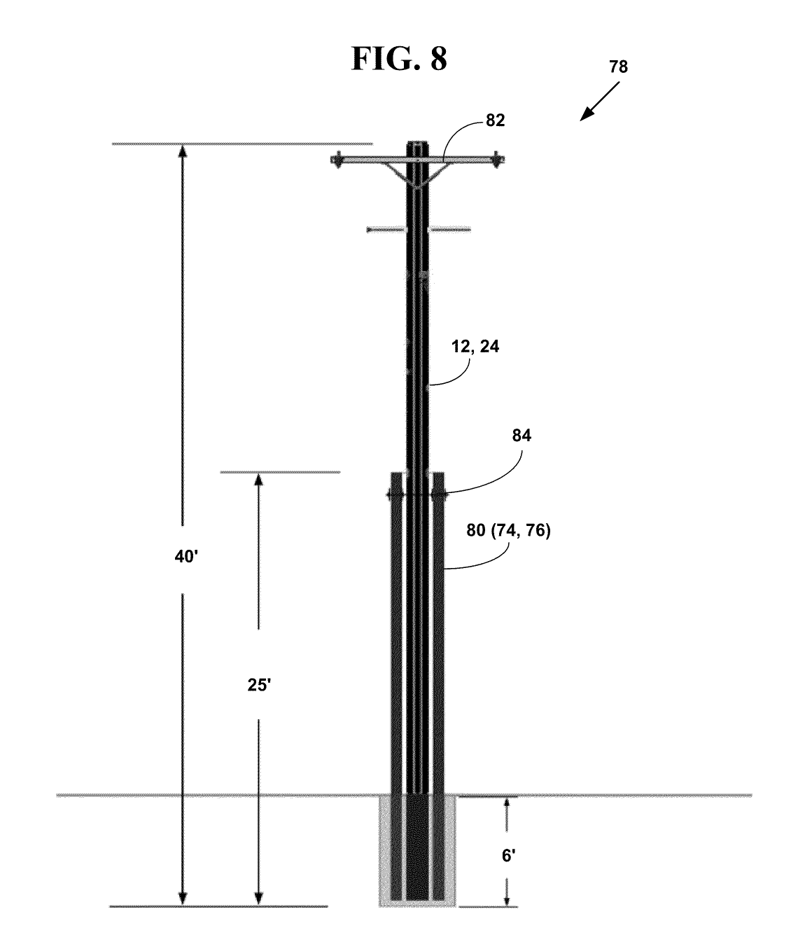

FIG. 8 is a block diagram 78 illustrating a side view of an exemplary transmission structure support component 80. The transmission structure support component 80 is illustrated with a single transmission pole 82. The single transmission pole 82 includes extruded and/or pultruded poles 10, 50. FIG. 8 illustrates the transmission structure support component 80 secured in 6 feet concrete and a total length of 25 feet. The exemplary transmission pole 82 is illustrated as 40 feet in length. However, the present invention is not limited to these lengths and measurements and other lengths measurements can also be used to practice the invention.

FIG. 8 illustrates the single transmission pole 82 through bolted 84 into the exemplary transmission structure support component 80. However, the present invention is not limited to such an attachment method and other attachment methods can also be used to practice the invention.

In one embodiment, the transmission structure support component 80 is used as the third leg component 72 and the fourth leg component 74 in the structure 56. However, the present invention is not limited to this embodiment and other embodiments may also be used to practice the invention.

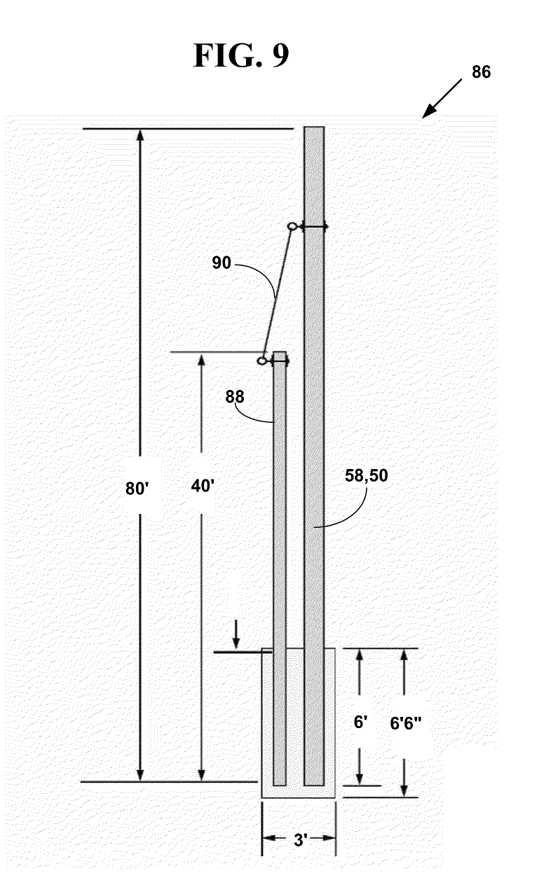

FIG. 9 is a block diagram 86 illustrating an additional support component 88 for the exemplary transmission support structure 56. The additional support component 88 may be used with first leg component 58 and/or second leg component 60 to provide additional support. The additional support component 88 provides additional lateral and medial support to the utility line support structure 56.

In one embodiment, the additional support component 88 is connected with a cable 90 via two eye bolts that are through bolted 84 through the legs 58, 60 and the additional support component 88. The cable can be metal, a composite material or other materials. However, the present invention is not limited to this embodiment and other types of attachments can also be used to practice the invention.

In one embodiment, the additional support component 88 includes extruded and pultruded hollow cylindrical components 10, 50. However, the present invention is not limited to this embodiment and types of structures in other size and shapes can also be used for the additional support component 88 (e.g., metal , wood, composite material, etc.).

In one embodiment, the additional support component 88 and the legs 58, 60 are placed 3 feet apart in an earth surface and embedded into concrete to a depth of 6 feet and/or 6 feet 6 inches to provide additional support. However, the present invention is not limited to this embodiment and other types of materials and embedding depths can also be used to practice the invention.

In one embodiment, the additional support component 88 can also be placed next to a single transmission pole 82. In another embodiment, the additional support component 88 is used to allow a the structure 56 or the single transmission pole 82 to be used as dead-end on a transmission line sequence. Dead-end towers have other differences from suspension towers as they are built stronger, they often have a wider base, and they often have stronger insulator strings to withstand the forces associated with the an end of transmission line sequence.

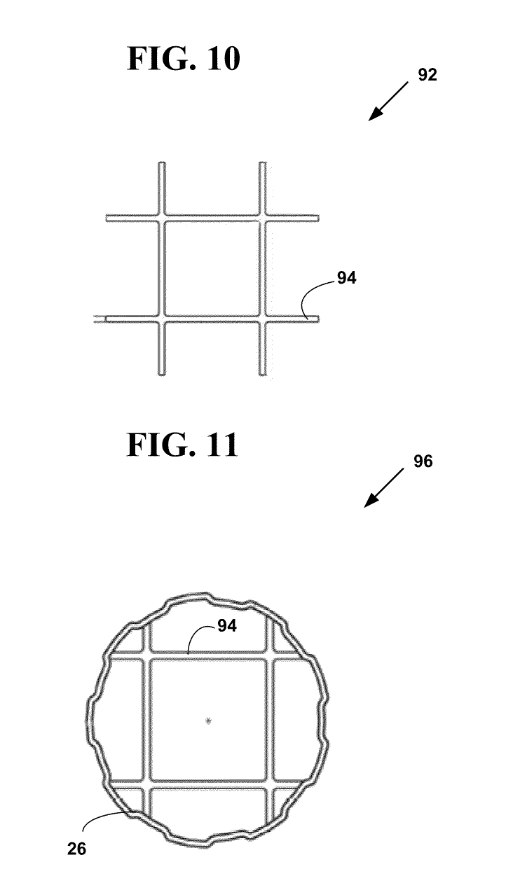

FIG. 10 is a block diagram 92 illustrating an internal support component 94 for an exemplary transmission support structure 56. The internal support component 94 provides additional tensional and torsional strength. In one embodiment, the internal support structure comprises the composite or plastic material including re-enforcing fibers as was described above for the extruded and/or pultruded components. In another embodiment, the integral support structure is made from a different material than the extruded and/or pultruded components. In one embodiment, the internal support component 94 (i.e., integral and/or removable) also includes integral copper wires, other metal wires so the internal support component can act as an antenna.

FIG. 11 is a block diagram 96 illustrating an internal support component 94 for an exemplary transmission support structure within pultruded hollow cylindrical component 50.

FIG. 11 illustrates the internal support component 94 within pultruded hollow cylindrical component 50 with structure 26. However, the same internal support component 94 is also used within extruded hollow cylindrical component 10 with structure 15 in a similar manner.

The internal support structure 94 provides additional lateral support (i.e., support for sideways movement) and medial (i.e., support for middle movement) support for the transmission structure 56.

In one embodiment, the internal support structure 94 is manufactured as an integral component of the extruded and pultruded hollow cylindrical components 10, 52. In another embodiment, the internal support structure is a separate removable component that is physically inserted into the extruded and pultruded hollow cylindrical components 10, 52.

In addition to support, the internal support structure 94 also provides plural separate channels in which wires and/or cables can be placed inside the extruded and pultruded hollow cylindrical components 14, 24. This prevents exposure of the wires and cables to the weather and makes the structure 56 more aesthetically appealing when viewed. In addition, the separate channels also provide insulation and help prevent electromagnetic interferences from electrical and magnetic currents generated by the wires and/or cables being used inside the hollow cylindrical components. Otherwise, electrical and magnetic currents generated by such wires and/or cables cause electrical and magnetic disturbances that may interrupt, obstruct, or otherwise degrade or limit the effective performance of an electrical circuit.

In one embodiment, the structure 56 includes both external electric transmission components for transmitted electricity and internal antenna components for telecommunications.

Attachable/Detachable Climbing Components

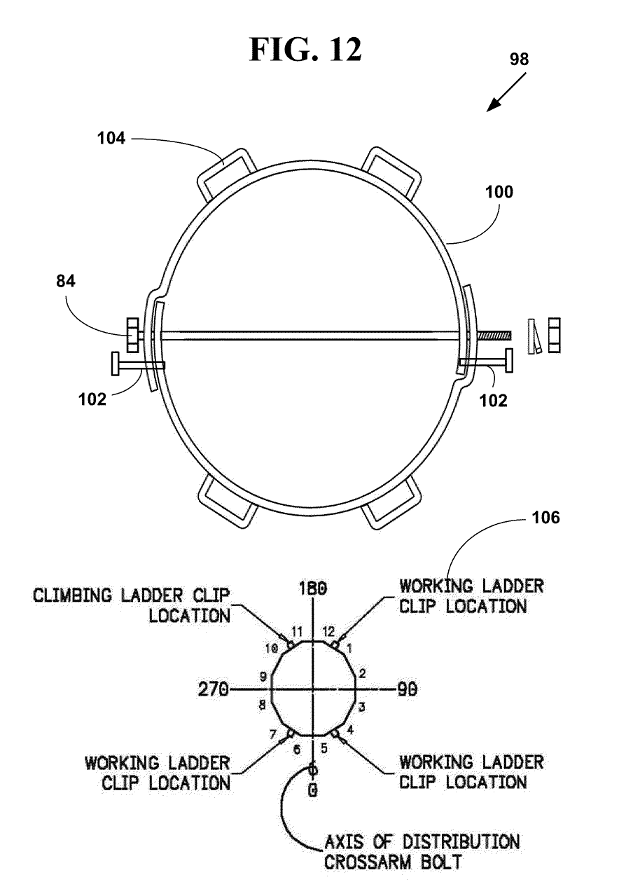

FIG. 12 is block diagram 98 illustrating an attachable/detachable climbing component 100 used on the exemplary utility line support structure 56. In the normal course of business, it is often necessary to allow maintenance workers to climb the extruded and pultruded hollow cylindrical components 10, 52 that make up the utility line support structure 56.

However, due to the shape of the cylinders and the material they are made of, conventional methods of free-climbing and/or climbing with lineman's spikes cannot be used. As a result, in one embodiment, the utility line support structure 56 includes an attachatable/detachable climbing component 100 that is used to climb on the structure.

Plural attachable/detachable climbing components 100 are used to create a base for a climbing ladder and/or for inserting climbing pegs. In one embodiment, the attachatable/detachable climbing component 100 comprises metal, plastic, rubber, wood, composite materials, or other materials.

In one embodiment, the attachatable/detachable climbing component 100 is through bolted 84 through pre-dilled holes in the structure 56. In another embodiment, the attachatable/detachable climbing component 100 is attached externally to the structure 56 without through bolting 84 and without using any pre-drilled holes and includes another type of tightening bolt 102 that is used to pressure tighten the attachatable/detachable climbing component 100 to the structure 56. Only two tightening bolts 102 are illustrated in FIG. 12. However, more or fewer tightening bolts may also be used to practice the invention.

The attachatable/detachable climbing component 100 includes plural climbing receptacles 104 that engage climbing components such as climbing pegs, climbing ladder rungs, etc. FIG. 12 also includes an exemplary attachment pattern 106 for attaching a climbing ladder typically used for transmission poles and/or legs of transmission towers. However, the present invention is not limited to such an attachment pattern 106 and other attachment patterns can also be used to practice the invention.

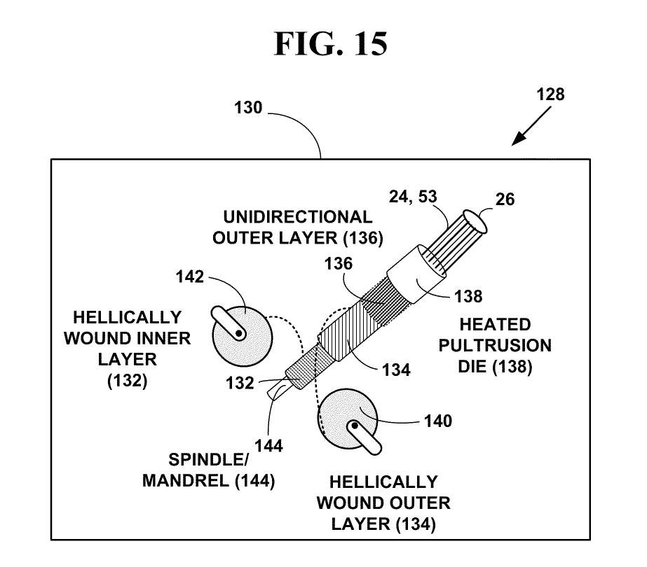

In one embodiment, the pultruded hollow cylindrical components 24, 53, and components of structure 56 including pultruded structure 52 comprise an overwrapping transverse winding process, a pullwinding process, that combines continuous filament winding with pultrusion to produce a pultruded hollow cylindrical structure with the shape of hollow cylindrical structure 50 that is used in structure 56. (See FIG. 15 and related text).

This “pullwinding” process incorporates longitudinal reinforcements with helical-wound layers, providing maximum tensil strength, torsional strength and hoop strength. As is known in the art, the “tensile strength” is a maximum stress that a material can withstand before necking As is known in the art “necking” is a mode of deformation where relatively large amounts of strain localize disproportionately in a small region of an object. As is known in the art, “hoop strength” includes strength against a circumferential stress in a cylindrically shaped part as a result of an internal or external pressure and “torsional strength” is a strength against a twisting of an object due to an applied torque in a cylindrically shaped object, the resultant shearing stress is perpendicular to a radius of the object.

In one embodiment, the pultruded hollow cylindrical components are formed using a self-contained inline winding unit with a pultrusion machine is used feeding angled fibers between layers of unidirectional fibers before curing in a pultrusion die. The longitudinal fibers are used for axial and bending resistance while hoop fibers are used for hoop tension and compression resistance. The pullwinding equipment is comprised of twin winding heads which revolve in opposite directions over a spindle. However, the present invention is not limited to such an embodiment and other embodiments can also be used to practice the invention. (See FIG. 15).

The components of structure 56 allow transmission towers to be designed easier, manufactured cheaper, installed easier and quicker and maintained easier than those made of other material such as steel, other metals, wood, etc.

Apparatus For Transporting And Raising Pultruded/Extruged Structures

Even though the extruded and/or pultruded hollow cylindrical components 10, 52, 56, 82 are lighter than conventional utility poles and/or steel components for utility transmission structures, they are still difficult to transport, handle and install due to their long lengths. As a result, an apparatus for transporting, raising and pultruded/extruded structures 10, 52, 56, 82 is presented. The apparatus is made from the same materials as the extruded structures 10, 52, 56, 82 and provides the same strengths, resistances etc. as the components themselves.

The apparatus is lightweight and can be used on paved surfaces as well as off-road surfaces. The apparatus safely transports pultruded/extruded structures 10, 52, 56, 82 and includes a moveable boom that allows the pultruded/extruded structures to be raised into place and installed on virtually any type of terrain and virtually any slope.

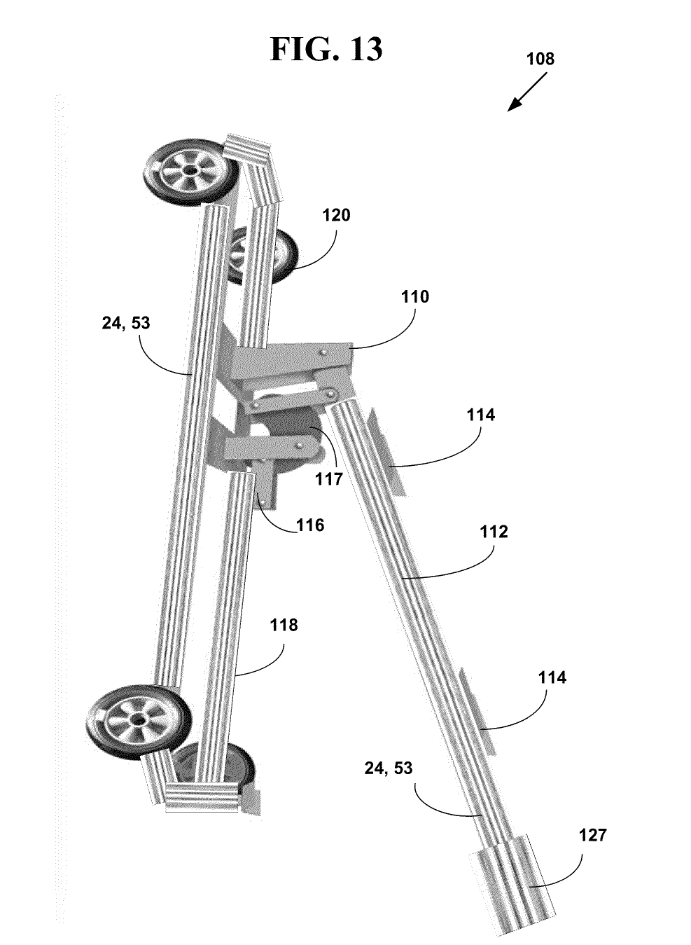

FIG. 13 is a block diagram 108 illustrating an apparatus 110 for transported, raising and installing pultruded and/or extruded structures 10, 52, 56, 82. The apparatus 110 includes a moveable boom 112 with plural structure engaging components 114. The moveable boom 112 provides a range of movement from a horizontal position to a vertical position and moves between the angles of at least zero degrees (e.g., horizontal, etc.) and at least 90 degrees (e.g., vertical, etc.). However the present invention is not limited to these angles and other angles can also be used to practice the invention. The horizontal position is used to transport the extruded and/or pultruded hollow cylindrical components 10, 52, 56, 82 to a desired site. The vertical position is used to install the extruded and/or pultruded hollow cylindrical components 10, 52, 56, 82 into a desired position such as a mounting hole (e.g., filled with wet concrete, etc.) at the desired site.

In one embodiment, the moveable boom 112 comprises a hollow pullwound pultruded cylindrical structure with an internal support structure 94. for providing additional tensional, torsional strength and hoop strength to the moveable boom 112.

The plural engaging components 114 engage extruded and pultruded hollow cylindrical components 10, 52, 56, 82 in plural places to prevent the extruded and pultruded hollow cylindrical components 10, 52, 56, 82. from rolling off the apparatus 110. Two engaging components are illustrated in FIG. 13. However, the present invention is not limited to this embodiment and more, fewer or other types of engaging components can also be used.

The apparatus 110 further includes a boom movement component 116. In one embodiment, the boom movement component 116 is a mechanical boom component that includes plural levers and at least one selectable and changeable counter weight 117 that allows the boom movement component 116 to move the boom 112 from a horizontal position to a vertical position when activated.

As is known in the art, counterweights often used in traction lifts, elevators cranes, etc.. In these applications, an expected load multiplied by a distance that load will be spaced from a central support (called the “tipping point”) and is equal to a counterweight's mass times its distance from the tipping point in order to prevent over-balancing either side. This distance times mass is called the “load moment.”

In one embodiment, the one or more counterweights 117 for the boom movement component 116 are selectable/changable/removable/attachable and are configured and change based on a weight of a extruded and pultruded hollow cylindrical components 10, 52, 56, 82 used. For example, a first extruded and pultruded hollow cylindrical components 10, 52 at a thirty foot length would be configured with a first counterweight 117 and a second extruded and pultruded hollow cylindrical components 10, 52 at an eighty foot length would be configured with a second heavier counterweight 117′ because the second extruded and pultruded hollow cylindrical components 10, 52 is a heavier weight.

The boom 112 is used to install extruded and pultruded hollow cylindrical components 10, 52, 56, 82 into a vertical position. For example, the boom 112 may be used to install an extruded and pultruded hollow cylindrical components 10, 52, 56, 82 at an angle between at least zero degrees and at least 90 degrees when an extruded and pultruded hollow cylindrical components 10, 52, 56, 82 is used on a surface that is sloped, is used as a dead-end component, etc.

In one embodiment, the moveable boom 112 comprises a first hollow pullwound pultruded cylindrical structure with a first smaller radius connected to boom movement component 116. A second hollow pullwound pultruded cylindrical structure 127 (FIG. 13) with a second larger radius is placed over the first hollow pullwound plutruded cylindrical structure for providing additional tensional, torsional strength and hoop strength to the moveable boom 112. The unique shape of repeating inner and outer surfaces of the hollow pullwound pultruded cylindrical structures provide an inter-locking that prevents movement and/or slippage of the structures and also prevents the hollow pullwound pultruded cylindrical structures from disengaging from each other. In such an embodiment, one or more additional counter weights 117 of heavier weight would be used.

In one embodiment, a set of additional hollow pullwound pultruded cylindrical structures with progressively larger radiuses is used. This set of additional hollow pullwound pultruded cylindrical structures allows the apparatus 110 to lift and lower progressively larger, longer and heavier pultruded and/or extruded structures.

The apparatus 110 further includes a support frame 118 for supporting the boom 112 and the boom movement component 116 and plural wheels 120.

In one embodiment, the support frame 118 comprises a hollow pullwound pultruded cylindrical structure with an internal support structure 94. for providing additional tensional, torsional strength and hoop strength to the support frame 118.

The plural wheel 120 are illustrated with smooth tires. However, the present invention also includes an apparatus 110 with all-terrain tires and various combinations of tires. The all-terrain tires include all rubber tires and/or tires with spikes made from metals, composite materials and other materials.

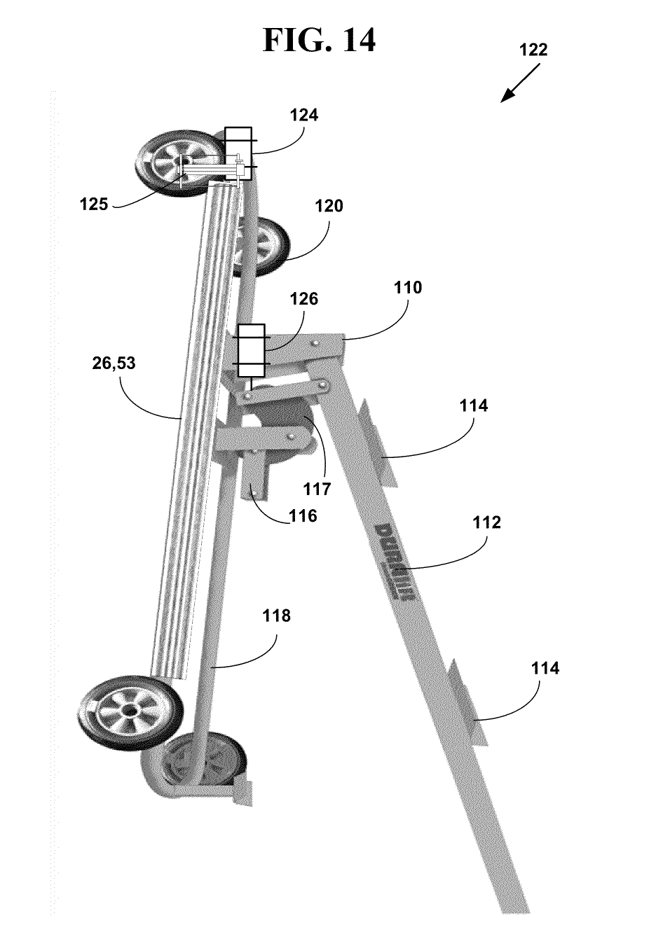

In one exemplary embodiment, the boom 112 and the support frame 118 (FIG. 13) comprise extruded and/or pultruded hollow cylindrical components 10, 24, 52, 56, 80, etc. In another embodiment, the apparatus 110 includes only the boom 112 comprising extruded and/or pultruded hollow cylindrical components 10, 24, 52, 56, 82 components. In another embodiment, In another embodiment, the apparatus 110 includes only the support frame 118 comprising extruded and/or pultruded hollow cylindrical components 10, 24, 52, 56, 82 components. In another embodiment, the apparatus 110 includes only selected portions of the support frame 118 (e.g., FIG. 14) comprising extruded and/or pultruded hollow cylindrical components 10, 24, 52, 56, 82 components. However, the present invention is not limited to this embodiment and other embodiments can also be used to practice the invention.

In another exemplary embodiment, the components of the apparatus 110 comprise light weight metals such aluminum, titanium, composite materials or other materials. In another embodiment, the apparatus 110 comprises steel components. However, the present invention is not limited to this embodiment and other materials and other embodiments can also be used to practice the invention.

In one exemplary embodiment, the plural wheels 120 include rubber tires. In another exemplary embodiment, the plural wheels 120 include tires made from wire, composite materials or other materials. In another exemplary embodiment, the plural wheels 120 include oversized, tires such as those used on swamp buggies in wet areas, such as swamps, bogs, tundra, etc. However, the present invention is not limited to these embodiments and other embodiments and other types of tires can also be used to practice the invention.

The apparatus 110 is light enough in weight, including pultruded/extruded structures 10, 24, 52, 56, 82 to be easily pushed and/or pulled behind a vehicle or pushed and/or pulled by a human puller.

FIG. 13 illustrates an apparatus 110 that does not include any power transport means and needs to be pulled with a vehicle or via a human or an animal (e.g., horse, mule, etc.) and activated to raise pultruded/extruded structures 10, 24, 52, 56, 82.

FIG. 14 illustrates an apparatus 122 that includes a power transport means 124 and does not need to be pulled with a vehicle or via a human puller. In one embodiment, the power transport means 124 includes an electric power source with one or more batteries, plural capacitors in which electrical currents are stored and generated with a hand crank, an internal combustion power source that requires a natural gas, gasoline, diesel, hydrogen, etc. The power transport means 124 further includes gears, rollers 125, etc. to engage the plural wheels 120. However, the present invention is not limited to these embodiments and other embodiments and other types of power transport means can also be used to practice the invention.

In such an embodiment with a power transport means a technician is able to easily transport both the apparatus 110 and pultruded/extruded structures 10, 24, 52, 56, 82 in any type of terrain without hard physical activity or the need for a transport animal.

In another embodiment, the apparatus 110 includes the power movement means 124, but is transported by a vehicle (e.g., maintenance truck, etc.) near an installation site. Then the power movement means 124 is started to transport the apparatus 110 to an exact installation site where the transport vehicle may not be able to reach (e.g., slope, swamp, bog, tundra, etc.).

In another embodiment, the apparatus 120 includes a second power movement means 126 is connected to the boom movement component 116 to move make it easier to move the boom 112. In another embodiment, the apparatus 110 includes the second power movement means s126 to lower and raise the boom 112 but not the first power movement means 124 to move the plural wheels 120 of the apparatus. However, the present invention is not limited to these embodiments and other combinations and other embodiments and other types of tires can also be used to practice the invention.

FIG. 15 is a block diagram 128 illustrating an exemplary pull winding, pultrusion process used to create pullwound pultruded structures for the present invention.

In one embodiment, the pullwound pultruded hollow cylindrical components (e.g., 24, 53, 56, 58) are formed using a self-contained inline winding unit with heat pultrusion included in a single machine 138. The machine 138 feeds angled fibers 132, 134 between layers of unidirectional fibers 136 before curing in a heated pultrusion die 138. The longitudinal fibers 136 are used for axial and bending resistance while hoop fibers 132, 134 are used for hoop tension and compression resistance. The pullwinding equipment is comprised of twin winding heads 140, 142 which revolve in opposite directions over a spindle or mandrel 144. The spindle or mandrel 144 is removed leaving a hollow pullwound pultruded cylindrical component.

The present invention includes an apparatus for transporting and raising pultruded and/or extruded structures. The apparatus is made of plural pullwound pultruded cylindrical structures identical or similar to the pultruded and/or extruded structures. The apparatus allows pultruded and/or extruded structures to be transported, raised and installed in various types of terrain.

It should be understood that the processes, methods and system described herein are not related or limited to any particular type of component unless indicated otherwise. Various combinations of general purpose, specialized or equivalent components combinations thereof may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer or equivalent elements may be used in the block diagrams.

The claims should not be read as limited to the elements described unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. An apparatus for transporting, raising and installing utility structures, comprising in combination:
a moveable boom means comprising a pullwound pultruded cylindrical structure with a pre-determined inner and outer shape and with plurality of engaging components for lifting and lowering pultruded or extruded structures, wherein the pullwound pultruded cylindrical structure includes longitudinal reinforcements with a plurality of helical-wound layers, the plurality of helical-wound layers and pre-determined inner and outer shape providing maximum tensil strength, torsional strength and hoop strength, wherein the plurality engaging components engage the pultruded or extruded structures in a plurality of places and prevent the pultruded or extruded structures from rolling off the moveable boom means and wherein the moveable boom means is connected to a boom movement means;
the boom movement means with a plurality of mechanical levers and at least one selectable and changeable counter weight connecting the moveable boom means to a support frame means, the boom movement means providing a range of movement for the moveable boom means from at least a horizontal position to at least vertical position, wherein the plurality of mechanical levers and at least one selectable counter weight counterbalance a weight of the pultruded or extruded structures placed on the movable boom means and allow the moveable boom means to be moved in the range of movement in a smooth balanced manner using a force less then would be required to directly physically lift the weight of the plutruded or extruded structures;
the support frame means comprising one or more other pullwound pultruded cylindrical structures with the pre-determined inner and outer shape for supporting the moveable boom means and the boom movement means and for attaching a plurality of wheel means; and
the plurality of wheel means attached to the support frame means for moving the apparatus from place to place.

2. The apparatus of claim 1 wherein the pullwound pultruded cylindrical structure with the pre-determined inner and outer shape includes a hollow cylindrical structure comprising:
a repeating pattern of a plurality of alternating protruding components and intruding components forming an external surface and internal surface of the hollow cylindrical structure, wherein the repeating pattern of the plurality of alternating protruding components and intruding components of the hollow cylindrical structure provide tensile strength, torsional strength and hoop strength to the hollow cylindrical structure and wherein a shape created by the repeating pattern of the plurality of alternating protruding components and intruding components provides an optimal wind shear resistance for the hollow cylindrical structure distributing wind forces down along a length of the structure;
the external surface including the plurality of protruding components integrally connected to the plurality of intruding components with a plurality of curved connection components, wherein an individual protruding component includes two individual curved connection components connecting the individual protruding component to two individual intruding components and wherein the two individual curved connection components form an integral portion of both the individual protruding component and an integral portion of the two individual intruding components;
the internal surface including the plurality of intruding components integrally connected to the plurality of protruding components with the plurality of curved connection components, wherein an individual intruding component includes two other individual curved connection components for connecting the individual intruding component to two individual protruding components and wherein the two other individual curved connection components form another integral portion of both the individual intruding component and another integral portion of the two other individual protruding components;
the plurality of curved connection components each including a pre-determined curved connection component radius with two separate curved connection component outer radius portions forming two separate integral outer portions of an individual protruding component and two separate curved connection component inner radius portions forming two separate integral inner portions of an individual intruding component;
a pre-determined hollow cylindrical structure inner radius from a center point to an inner portion of the internal surface; and
a pre-determined hollow cylindrical structure outer radius from the center point to an outer portion the external surface, wherein the difference between the pre-determined hollow cylindrical structure inner radius and pre-determined hollow cylindrical structure outer radius determines a thickness of the hollow cylindrical structure, and wherein the hollow cylindrical structure includes a pre-determined length.

3. The apparatus of claim 1 wherein the wheel means include rubber tires, rubber tires with spikes and tires made from wire or composite materials.

4. The apparatus of claim 1 further comprising:
a power transport means connected to the moveable boom means for raising and lowering the moveable boom means.

5. The apparatus of claim 1 further comprising:
a power transport means connected to one or more of the plurality of wheel means for moving the apparatus from a first place to a second place.

6. The apparatus of claim 1 further comprising:
the support frame means comprising a first portion including one or more other pullwound pultruded cylindrical structures the pre-determined inner and outer shape and a second portion including a metal, other plastic or composite material.

7. The apparatus of claim 1 further comprising:
the moveable boom means comprising a first portion including first portion including one or more other pullwound pultruded cylindrical structures the pre- determined inner and outer shape and a second portion including a metal, other plastic or composite material.

8. The apparatus of claim 1 further comprising:
the moveable boom means comprising a hollow pullwound pultruded cylindrical structure with an internal support structure for providing additional tensional, torsional strength and hoop strength to the moveable boom means.

9. The apparatus of claim 1 further comprising:
the support frame means comprising a hollow pullwound pultruded cylindrical structure with an internal support structure for providing additional tensional, torsional strength and hoop strength to the support frame means.

10. The apparatus of claim 1 further comprising:
a second hollow first portion including the pullwound pultruded cylindrical structure with the pre-determined inner and outer shape placed over the moveable boom means for providing additional tensional, torsional strength and hoop strength to the moveable boom means and for allowing the moveable boom means to lift heavier extruded or pultruded structures, wherein the second hollow pullwound pultruded cylindrical structure includes a larger radius and diameter larger than an original radius and diameter of the moveable boom means.

11. An apparatus for transporting, raising and installing pultruded or extruded structures, comprising in combination:
a moveable boom means comprising a hollow pullwound pultruded cylindrical structure with a pre-determined inner and outer shape and with plurality of engaging components for lifting and lowering the pultruded or extruded structures, wherein the hollow pullwound pultruded cylindrical structure includes longitudinal reinforcements with a plurality of helical-wound layers, the plurality of helical-wound layers and pre- determined inner and outer shape providing maximum tensil strength, torsional strength and hoop strength, wherein the plurality engaging components engage the pultruded or extruded structures in a plurality of places and prevent the pultruded or extruded structures from rolling off the moveable boom means and wherein the moveable boom means is connected to a boom movement means;
the boom movement means connecting the moveable boom means to a support frame means with a plurality of mechanical levers and at least selectable and changeable one counter weight for providing a range of movement for the moveable boom means from at least a horizontal position to at least vertical position, wherein the plurality of mechanical levers and at least one selectable and changeable counter weight counterbalance a weight of the pultruded or extruded structures placed on the movable boom means and allow the moveable boom means to be moved in the range of movement in a smooth balanced manner using a force less then would be required to physically lift the weight of the plutruded or extruded structures;
the support frame means comprising the hollow pullwound pultruded cylindrical structure for supporting the moveable boom means and the boom movement means and a plurality of wheel means;
the plurality of wheel means connected to the support frame means for moving the apparatus from place to place; and
a plurality of other hollow pullwound pultruded cylindrical structures with a plurality of different radiuses for placing over the moveable boom means for providing additional tensional, torsional strength and hoop strength to the moveable boom means and for allowing the moveable boom means to lift heavier extruded or pultruded structures, wherein individual hollow pullwound pultruded cylindrical structures in the plurality of other hollow pullwound pultruded cylindrical structures include radiuses larger than a radius of the moveable boom means, wherein selected ones of the individual hollow pullwound pultruded cylindrical structures have radiuses larger than other selected ones of the individual hollow pullwound pultruded cylindrical structures and wherein the pre-determined inner and outer shape of the pullwound pultruded cylindrical structures interlock to prevent the hollow pullwound pultruded cylindrical structures from slipping or from disengaging from each other.

12. The apparatus of claim 11 wherein the hollow pullwound pultruded cylindrical with the pre-determined inner and outer shape includes a hollow cylindrical structure comprising:
a repeating pattern of a plurality of alternating protruding components and intruding components forming an external surface and internal surface of the hollow cylindrical structure, wherein the repeating pattern of the plurality of alternating protruding components and intruding components of the hollow cylindrical structure provide tensile strength, torsional strength and hoop strength to the hollow cylindrical structure and wherein a shape created by the repeating pattern of the plurality of alternating protruding components and intruding components provides an optimal wind shear resistance for the hollow cylindrical structure distributing wind forces down along a length of the structure;
the external surface including the plurality of protruding components integrally connected to the plurality of intruding components with a plurality of curved connection components, wherein an individual protruding component includes two individual curved connection components connecting the individual protruding component to two individual intruding components and wherein the two individual curved connection components form an integral portion of both the individual protruding component and an integral portion of the two individual intruding components;
the internal surface including the plurality of intruding components integrally connected to the plurality of protruding components with the plurality of curved connection components, wherein an individual intruding component includes two other individual curved connection components for connecting the individual intruding component to two individual protruding components and wherein the two other individual curved connection components form another integral portion of both the individual intruding component and another integral portion of the two other individual protruding components;
the plurality of curved connection components each including a pre-determined curved connection component radius with two separate curved connection component outer radius portions forming two separate integral outer portions of an individual protruding component and two separate curved connection component inner radius portions forming two separate integral inner portions of an individual intruding component;
a pre-determined hollow cylindrical structure inner radius from a center point to an inner portion of the internal surface; and
a pre-determined hollow cylindrical structure outer radius from the center point to an outer portion the external surface, wherein the difference between the pre-determined hollow cylindrical structure inner radius and pre-determined hollow cylindrical structure outer radius determines a thickness of the hollow cylindrical structure, and wherein the hollow cylindrical structure includes a pre-determined length.
